(19) United States
(12) Patent Application Publication
(10) Pub. No.: US 2025/0226557 A1
(43) Pub. Date: Jul. 10, 2025

(54) INSULATOR FOR TABLESS JELLYROLL BATTERY CELLS

(71) Applicant: TECHTRONIC CORDLESS GP, Anderson, SC (US)

(72) Inventors: Dan GENG, Dongguan City (CN); Denis Gaston FAUTEUX, Hong Kong (CN); Jin Wei LI, Dongguan City (CN)

(21) Appl. No.: 19/103,392

(22) PCT Filed: Mar. 15, 2022
(86) PCT No.: PCT/CN22/80830

§ 371 Date: Feb. 12, 2025

(51) Int. Cl. H01M 50/586; H01B 3/42; H01M 50/107; H01M 50/131; H01M 50/536; H01M 50/593

(52) U.S. Cl. CPC H01M 50/586; H01B 3/423; H01B 3/427; H01M 50/107; H01M 50/131; H01M 50/536; H01M 50/593

(57) ABSTRACT

A cylindrical battery cell comprising a jelly roll assembly comprising an anode sheet, a cathode sheet, a rubbing region formed at an uncoated region at the end of one of the anode sheet and the cathode sheet. The cylindrical battery cell further includes one or more separator sheets that separate the anode from the cathode and a header, a weld plate that provides an electrical connection between the jelly roll assembly and the header, and an outer housing and an insulator that separates the jelly roll assembly from the outer housing. The insulator includes a neck portion, an angular portion, a skirt portion, and a tapered portion. The neck portion is positioned between the outer housing and an extension portion of the weld plate. The angular portion is positioned between the neck portion and the skirt portion and positioned between the rubbing region and the outer housing.

### TECHNICAL FIELD

The present application relates generally to battery cells, and in particular, to specific insulator designs for tabless jelly roll battery cell configurations.

### BACKGROUND

Batteries, or battery cells, are critical in providing power to many electrical devices that are relied upon daily. Cylindrical batteries with a rolled arrangement are commonly used to power electrical devices. These battery types are often referred to as “jelly roll” batteries. A rolled cylindrical battery generally includes an anode and a cathode rolled cylindrically together with small gaps between concentric layers of the roll and placed into a battery housing with electrical terminals provided at either end of the housing. In tabless jelly roll battery cells, a conductive sheet generally runs the length of the cathode and/or the anode. The conductive sheet of each concentric layer of the roll may be rubbed (or otherwise formed) together with the other conductive sheets of each concentric layer of the jelly roll at a rubbing region such that they are able to form a connection point to effectively electrically connect to the electrical terminal of the battery housing. Insulators are required to provide electrical insulation between the rubbing region (or other conductive portions of the jelly roll) to other electrically conductive surfaces of the battery cell.

### SUMMARY

The battery cells described herein include configurations of an insulator for a jelly roll battery cell. Jelly roll battery cells generally include an insulator to prevent contact of the anodes, cathodes, and separator sheets of the jelly roll design to the outside can (or other conductive portion) of the cylindrical battery. Furthermore, an insulator is placed so that the spacing and all contacts within the cylindrical battery are maintained, even though an external event may have occurred (e.g., vibrations, falling, shock, etc.). The insulator will prevent the cylindrical battery assembly, as well as the jelly roll battery cell assembly, from being damaged or misaligned, and will ultimately prevent short circuiting between the jelly roll battery cell assembly and the cylindrical battery case.

Embodiments described herein describe a cylindrical battery cell. The cylindrical battery cell includes an anode sheet, a cathode sheet, and one or more separator sheets that separates the anode sheet from the cathode sheet. A rubbing region is positioned at a first end of the jelly roll assembly and formed at a first portion of an uncoated region at the first end of one of the anode sheet and the cathode sheet. The cylindrical battery cell further includes a header, a weld plate, and an outer housing. The weld plate is configured to provide an electrical connection between the jelly roll assembly and the header. The cylindrical battery cell also includes an insulator configured to separate a portion of the jelly roll assembly from the outer housing. The insulator includes a neck portion, an angular portion, a skirt portion, and a tapered portion. The neck portion is positioned between the outer housing and an extension portion of the weld plate. The angular portion connects the neck portion to the skirt portion and is positioned between the rubbing region and the outer housing. The skirt portion is parallel to the neck portion and is positioned between at least the first portion of the uncoated region. The tapered portion is parallel to both the neck portion and the skirt portion and positioned between at least a portion of the jelly roll assembly and the outer portion.

Other embodiments described herein provide a tabless battery cell. The tabless battery cell includes a cylindrical housing, a header, a first electrode sheet, a second electrode sheet, one or more separator sheets, a weld plate, and an insulator. The separator sheets separate the first electrode sheet and the second electrode sheet. The first electrode sheet, the second electrode sheet, and the one or more separator sheets are rolled together to form a jelly roll assembly. The jelly roll assembly further includes a rubbing region formed at a first end of the jelly roll assembly. The weld plate is coupled to the rubbing region. The insulator is positioned between the jelly roll assembly and the housing at the first end. The insulator includes a neck portion positioned between the outer housing and an extension portion of the weld plate. The insulator also includes a skirt portion parallel to the neck portion and positioned between at least a first portion of the jelly roll assembly and the outer housing. The insulator also includes an angular portion connecting the neck portion to the skirt portion and positioned between the rubbing region and the outer housing. The insulator also includes a tapered portion parallel to both the next portion and the skirt portion and positioned between at least a portion of the jelly roll assembly and the outer housing.

Other embodiments described herein provide an insulator of a jelly roll. The insulator includes a neck portion, a skirt portion, an angular portion, and a tapered portion. The neck portion extends towards a header of the jelly roll battery assembly. The skirt portion is parallel to the neck portion and is positioned between a portion of a rolled electrode assembly of the jelly roll battery assembly and an outer housing of the jelly roll battery assembly. The angular portion protruding at an angle from the neck portion, connects the neck portion to the skirt portion. The tapered portion is parallel to the neck portion and the skirt portion and is positioned below the neck portion and the skirt portion.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings. connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices.” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a battery cell assembly, according to some embodiments.

FIG. 2 illustrates an exploded view of a battery assembly, according to some embodiments.

FIG. 3 is a cross-sectional view illustrating an interior of the battery assembly of FIG. 2, according to some embodiments.

FIG. 4 is a perspective view of an insulator, according to some embodiments.

FIG. 5 is a top view of the insulator of FIG. 4, according to some embodiments.

FIG. 6 is a side view of the insulator of FIG. 4, according to some embodiments.

FIG. 7 is a magnified cross-sectional view of the battery assembly of FIG. 2, according to some embodiments.

FIG. 8 is an alternate embodiment of the insulator of FIG. 4, according to some embodiments.

FIG. 9 is a further alternate embodiment of the insulator of FIG. 4, according to some embodiments.

### DETAILED DESCRIPTION

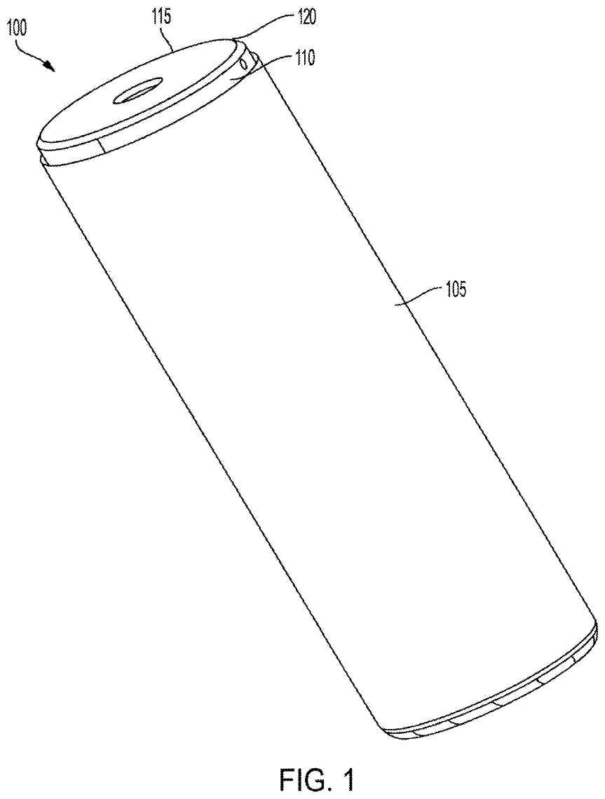

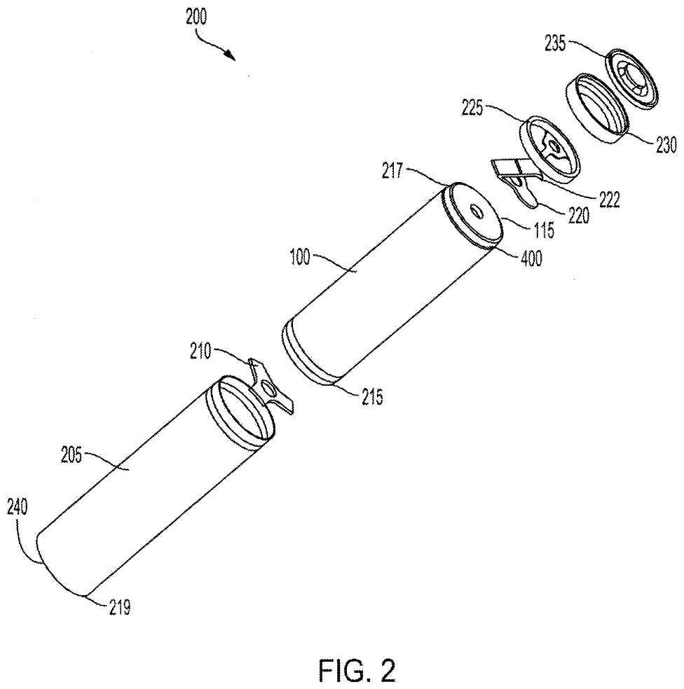

FIG. 1 illustrates an embodiment of a jelly roll 100 of a tabless battery assembly, such as jelly roll battery assembly 200 (FIG. 2), according to some embodiments. The jelly roll 100 is formed by rolling together an anode sheet, a cathode sheet, and at least one separator sheet, as will be described in detail below. In some embodiments, an insulator sheet 105 may be provided on the exterior of the jelly roll 100. For example, the insulator sheet 105 may be formed of a separator sheet that is rolled with electrodes in the jelly roll 100. In other embodiments the insulator sheet 105 may be omitted. An uncoated portion 110 of an electrode sheet (e.g., an anode sheet and/or a cathode sheet) is provided at a first end 120 of the jelly roll 100. The uncoated portion 110 may undergo a rubbing process to form a rubbing region 115. In some examples, a second rubbing region 117 is provided at a second end of the jelly roll 100 and is formed similar to the rubbing region 115. The rubbing process and rubbing region 115 are described in more detail below. The rubbing region 115 allows the uncoated portion 110 of the jelly roll 100 to be coupled directly to a second weld plate 220 at the first end 120 of the jelly roll 100. The second weld plate 220 may then provide an electrical connection between electrode of the jelly roll 100 and battery terminals, as described in more detail below.

The jelly roll 100 may have a nominal voltage between approximately 1 V and approximately 5 V and a nominal capacity between about 1 Ah and about 5 Ah or more (e.g., up to about 9 Ah). The jelly roll 100 may have any rechargeable chemistry type, such as, for example Lithium (“Li”), Lithium-ion (“Li-ion”), other Lithium-based chemistry, Nickel-Cadmium (“NiCd”), Nickel-metal Hydride (“NiMH)”, etc.

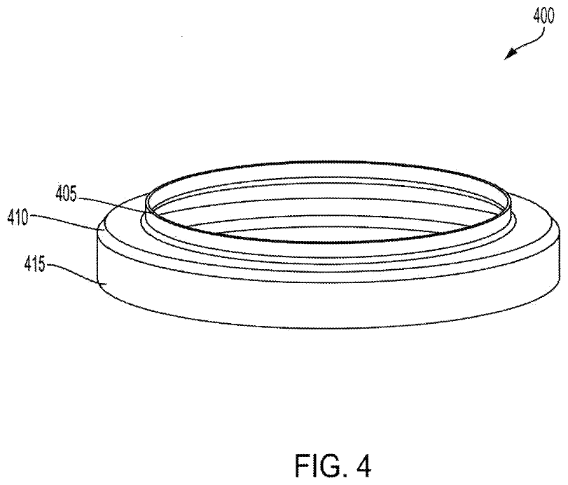

FIG. 2 illustrates a jelly roll battery assembly 200 according to some embodiments. The jelly roll battery assembly 200 includes a battery cell case 205, a first weld plate 210, the jelly roll 100, a second weld plate 220, a first insulating member 225, a second insulating member 230, and a terminal 235. The first insulating member 225 can be an insulator 400 (FIG. 4), as will be described in more detail below.

The battery cell case 205 is a casing in which the jelly roll 100 is seated, along with the jelly roll battery assembly 200 components described herein. In some embodiments, the battery cell case 205 may be referred to as a “can.” In some embodiments, the battery cell case 205 may be made of an insulative material. For example, the battery cell case 205 may be made of plastic or other non-conductive materials. Alternatively, in some embodiments, the battery cell case 205 may be made of a conductive material, such as steel, aluminum, or any other suitable metal. In some embodiments, the battery cell case 205 functions as a negative second terminal 240 at a distal end 215 of the battery cell case 205 to facilitate an external connection.

The first weld plate 210 may be affixed to the distal end 215 of the jelly roll 100. For example, the first weld plate 210 may be welded to a rubbing region 115 at the distal end 215 of the jelly roll 100 using one of laser welding, ultrasonic welding, and/or the like. In some embodiments, the first weld plate 210 may be comprised of a conductive material such as, but not limited to, nickel, copper, and/or the like. The second weld plate 220 may be affixed to a rubbing region 115, such as the rubbing region 115, at a proximal end 217 of the jelly roll 100. Similar to the first weld plate 210, the second weld plate 220 may be comprised of a conductive material such as, but not limited to, nickel, copper, and/or the like. In some embodiments, the second weld plate 220 may have a tab portion 222 extending radially inward and upward from an edge of the second weld plate 220. In some embodiments, the first insulating member 225 is made of plastic and/or rubber. The first insulating member 225 is provided with through holes such that the tab portion 222 will extend through the through hole and be welded to the terminal 235. The first insulating member 225 prevents contact between the tab portion 222 and the battery cell case 205.

In some embodiments, the second insulating member 230 may be a gasket made of an insulating material. The second insulating member 230 may be sandwiched between the terminal 235 and the battery cell case 205 to prohibit electrical contact between the terminal 235 and the battery cell case 205. In some embodiments, a height of the second insulating member 230 height may be reduced due to the additional insulation provided by the insulator 400, thus negating the need for an additional gasket to provide electrical isolation between the terminal 235 and the battery cell case. With the reduction of height of the second insulating member 230, move space within the jelly roll battery assembly 200 is available. This additional space within the jelly roll battery assembly 200 may allow for an increase of the power density of the jelly roll 100, which can further increase the efficiency of the jelly roll battery assembly 200. For examples, increased space within the jelly roll battery assembly can allow for larger anode sheets and cathode sheets (as described below) to be placed within the jelly roll battery assembly 200, thereby increasing the power density.

The terminal 235 is an electrical contact that connects an electrode sheet (e.g., anode sheet, or cathode sheet) of the jelly roll 100 to an external device in order to provide electrical power to the external device. In some embodiments, the terminal 235 may receive power from an external device to recharge the jelly roll 100. In some embodiments, the terminal 235 is a positive electrode and is therefore electrically connected to the positive electrode sheet within the jelly roll 100. For example, the terminal 235 may connect the positive electrode sheet of the jelly roll 100 to a positive terminal of an external device that is to be powered by the jelly roll battery assembly 200. In some embodiments, the terminal 235 is made of metal. For example, the terminal 235 may be made of stainless steel, copper, tin, silver, and/or various metals and alloys as appropriate for a given application.

A negative second terminal 240 is formed when the first weld plate 210 is connected to the distal end 215 of the battery cell case 205, as the jelly roll 100 and the first weld plate 210 are seated in the battery cell case 205.

In some embodiments, the jelly roll 100 uses a tabless design. Typically, tabless electrode assemblies may not include battery tabs that are attached to one or more of the anode and the cathode, which serve to connect the anode and the cathode to a respective battery terminal. Battery designs using a tabbed configuration may have increased resistance due to the required tabs, resulting in reduced current capacity of the battery. Thus, tabless electrode assemblies may have a reduced impedance between an output terminal and the anode and/or cathode, resulting in an increased current capacity over a tabbed battery configuration.

In some embodiments, the jelly roll 100 includes an electrode assembly comprising an anode sheet, one or more separator sheets, and a cathode sheet. In some embodiments, the anode sheet, the one or more separator sheets, and the cathode sheet are planar sheets that can be rolled to form a roll with concentric layers, such as a rolled electrode assembly. In some embodiments, multiple separator sheets may be used in the assembly. For example, a second separator sheet may be used to provide additional separation between a cathode sheet and an anode sheet when the electrode assembly is rolled.

The anode sheet may include a coated portion and an uncoated portion. In some embodiments, the anode sheet may be comprised of a base metal (e.g., copper (Cu)) with an anode material coated on a predetermined portion of the base metal to form the coated portion. The anode material forming the coated portion may be comprised of graphite (C₆), graphene (e.g., graphene encapsulated silicon (Si) nanoparticles), silicon, silicon dioxide, etc. The uncoated portion 110 may include a metallic or otherwise conductive surface to electrically couple to a terminal, such as the terminal 235. For example, the uncoated portion 110 may have a metallic surface such as copper, aluminum, or other applicable metallic material.

The cathode sheet includes a coated portion and an uncoated portion, such as uncoated portion 110 (FIG. 1). In some embodiments, the cathode sheet may be comprised of a base metal (e.g., aluminum (Al)) with a cathode material coated on a predetermined portion of the base metal to form the coated portion. The cathode material forming the coated portion may be comprises of lithium cobalt oxide (LiCoO₂), lithium nickel manganese cobalt oxide (LiNiₓMn_{y}Co_{z}O₂ (x+y+z=1) or NMC), lithium nickel cobalt aluminum oxide (LiNiₓCo_{y}Al_{z}O₂ (x+y+z=1)), a polyanion (e.g., such as lithium iron phosphate (LiFePO₄)), a spinel (such as lithium manganese oxide (LiMn₂O₄, Li₂MnO, or LMO)), etc. The uncoated portion 110 may include a metallic or otherwise conductive surface to electrically coupled to a terminal, such as the terminal 235.

The separator sheet is interspersed between the anode sheet and the cathode sheet. The separator sheet is a medium that allows the passage of ions between the anode sheet and the cathode sheet. For example, in a Lithium-ion battery cell, the separator sheet allows lithium-ion atoms to pass through while blocking electrons from passing through. In some embodiments, the separator sheet may have a thickness of 20 micrometers. However, thicknesses of more than 20 micrometers or less than 20 micrometers are also contemplated. In some embodiments, the separator sheet may be made of polyethylene (PE), polypropylene (PP), or other material suitable for a given application.

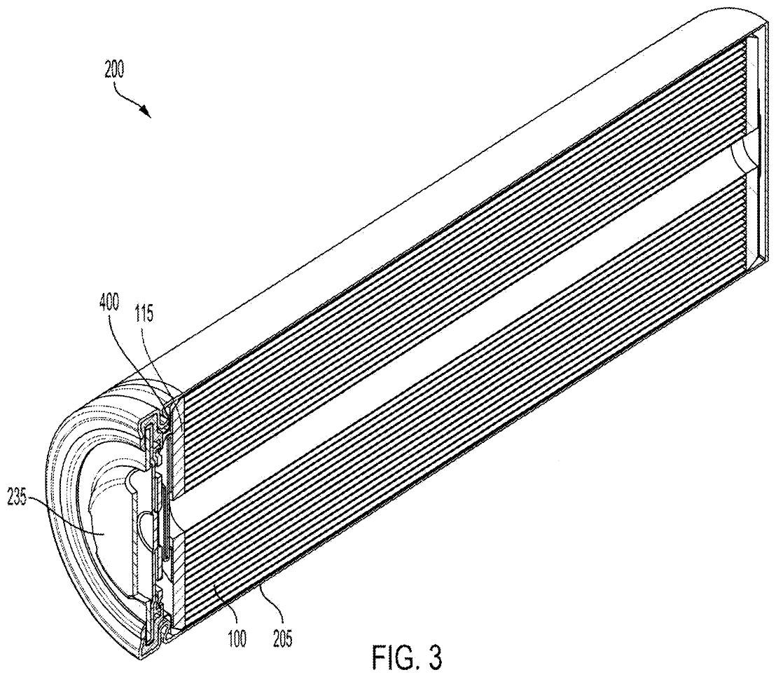

FIG. 3 illustrates a cross-sectional view of the jelly roll battery assembly 200, according to some embodiments. The jelly roll battery assembly 200 includes the jelly roll 100, the terminal 235, the battery cell case 205, and the insulator 400.

In some embodiments, the rubbing region 115 is provided at the proximal end 217 of the jelly roll battery assembly 200. In some embodiments, the rubbing region 115 is comprised of concentric layers of the uncoated portion 110 that are rubbed together to create a flat surface. In one example, the flat surface is orthogonal to the jelly roll 100. For example, the uncoated portion 110 may be between one and four mm tall prior to the rubbing region 115 being formed during a rubbing process. After the rubbing process, the uncoated portion 110 may extend between one and two mm past the rolled sheets of the jelly roll 100. The rubbing region 115 connects the jelly roll 100 to a weld plate, such as second weld plate 220 (FIG. 2). In some embodiments, the rubbing region 115 is laser welded to the second weld plate 220.

FIG. 4 illustrates the insulator 400 according to some embodiments. In one embodiment, the insulator 400 is located between the jelly roll 100 and the terminal 235. The insulator 400 is designed to secure the components of the jelly roll 100 and prevent any of the interior components of the jelly roll 100 from exposure and risk of short circuiting to the battery cell case 205.

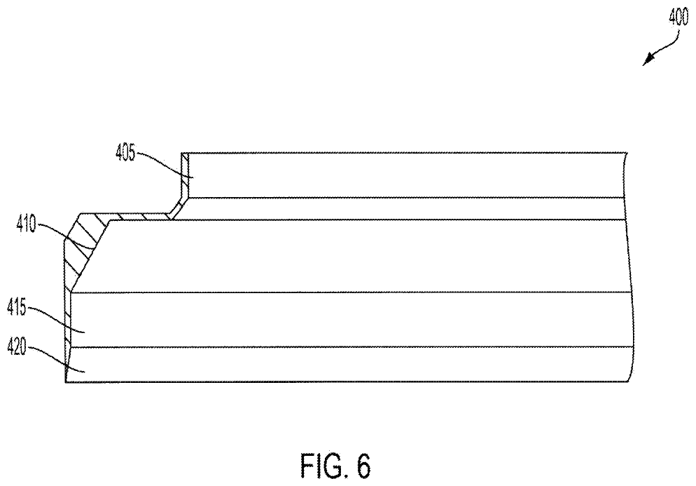

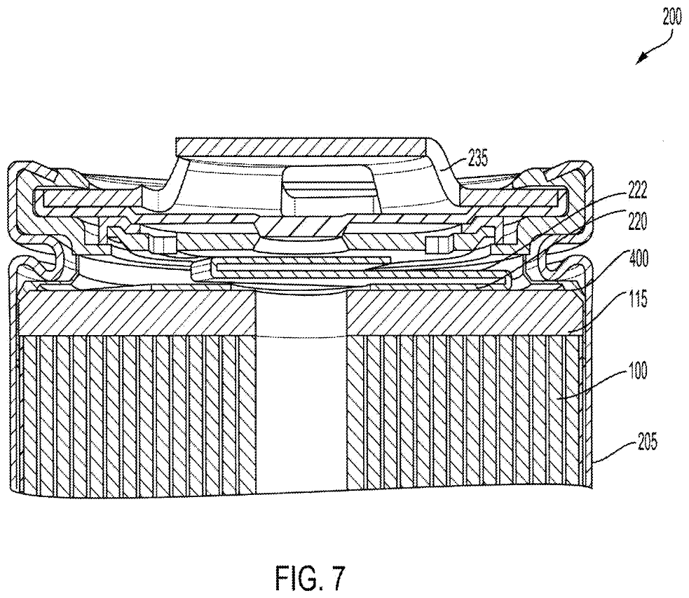

As shown in FIG. 4, the insulator 400 includes a neck portion 405, an angular portion 410, a skirt portion 415, and a tapered portion 420 (FIG. 6). The neck portion 405 is positioned circumferentially around a portion of the jelly roll 100 (as shown in FIGS. 3 and 7). The neck portion 405 transitions into the angular portion 410 of the insulator 400. In some embodiments, the angular portion 410 of the insulator 400 protrudes at an angle from the neck portion 405. In some embodiments, the angular portion 410 of the insulator 400 is designed to have a similar shape to that of a rubbing region (for example, rubbing region 115), such that the angular portion 410 conforms to the shape of the rubbing region 115. In some embodiments, the angular portion 410 provides heightened stability of the contents of the jelly roll 100, the rubbing region 115, and the battery cell case 205. For example, the insulator 400 may generally be positioned between the rubbing region 115 and the battery cell case 205 and conform to the shape of the rubbing region 115, thereby reducing movement of the jelly roll 100 and rubbing region 115 with respect to the battery cell case 205. In some embodiments, the reduced movement provided by the angular portion 410 provides more efficient wear resistance of portions of the jelly roll 100 (e.g., rubbing region 115), resulting in an increased lifespan of the jelly roll 100.

As shown in FIG. 6, in one embodiment, the angular portion 410 is the thickest portion of the insulator 400. The inner surface of the angular portion 410 can substantially conform to the outer surface of the rubbing region 115. In a further embodiment, there is a planar portion is parallel to the surface of the rubbing region 115.

The angular portion 410 transitions into the skirt portion 415 of the insulator 400. The skirt portion 415 is designed to be positioned between the jelly roll 100 below the rubbing region 115. In some embodiments, the angular portion 410 protrudes at an outward angle towards the battery cell case 205 to transition into the skirt portion 415. The angle can be within a range from 10 degrees to 45 degrees, preferably 30 degrees. The skirt portion 415 may be configured to extend generally parallel to the sides of the battery cell case 205. In some embodiments, the skirt portion 415 is parallel to the neck portion 405. The skirt portion 415 encloses a portion of the jelly roll 100 below the rubbing region 115, such as a portion of the uncoated portion 110 and/or the coated portions of the relevant electrode sheets.

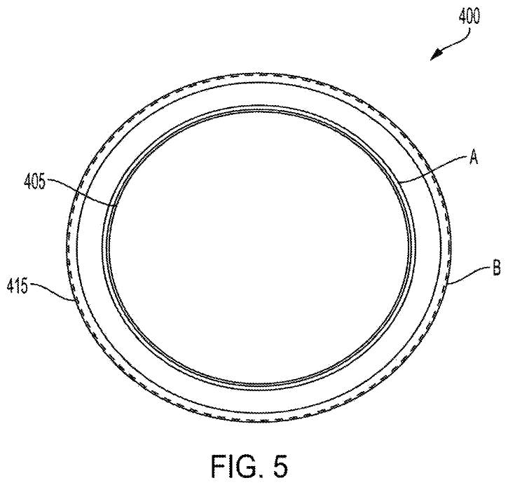

FIG. 5 shows the top view of the insulator 400 according to some embodiments, wherein an outermost diameter B is an external face of the skirt portion 415 and an innermost diameter A is the internal face of the neck portion 405. As shown in FIG. 4, the insulator 400′s diameter changes with each portion as to properly fit in the jelly roll battery assembly 200. In some embodiments, the insulator 400 is positioned between the jelly roll 100 and the terminal 235. In one embodiment, the neck portion 405 is configured to enclose the smaller diameter of the second weld plate 220, and the skirt portion 415 is configured to span the diameter of at least the jelly roll 100.

FIG. 6 illustrates a cross-sectional view of the insulator 400 according to some embodiments. The neck portion 405 extends down to the angular portion 410. The angular portion 410 extends to skirt portion 415.

Lastly, the skirt portion 415 is connected to a tapered portion 420 of the insulator 400. In some embodiments, the tapered portion 420 is parallel to the skirt portion 415. The tapered portion 420 is designed to allow for an easy assembly of the insulator 400 into the jelly roll 100 of FIG. 1, as the angle at which the tapered portion 420 protrudes towards the battery cell case 205 from the skirt portion 415, allows the insulator 400 to be coupled to the jelly roll 100 by accommodating the widest portion of the battery cell. In some embodiments, the tapered portion 420 is configured to improve assembly allowing the jelly roll 100 to easily be inserted into the insulator 400 at a widest portion provided by the tapered portion 420. In some embodiments, the tapered portion 420 is attached to the jelly roll 100 prior to welding the tab portion 222 to the terminal 235. The jelly roll 100 is then placed within the battery cell case 205 after welding the tab portion 222 to the terminal 235. In some embodiments, an inner diameter of the insulator 400 is equal to the diameter of the jelly roll 100 allowing for the insulator 400 to be press fit into the battery cell case 205. In another embodiment, the inner diameter of the insulator is larger than the diameter of the jelly roll 100, creating a loose fit of the insulator 400 within the battery cell case 205. The insulator 400 can be installed prior to or after the jelly roll 100 is placed within the battery cell case 205.

In some embodiments the insulator 400 is made of an insulative material. For example, the insulator 400 may be constructed of perfluoroalkoxy, polyethylene terephthalate, or other insulative material as required for given application.

FIG. 7 illustrates a magnified view of a portion of the jelly roll battery assembly 200 described above with regards to FIG. 3, according to some embodiments. In one embodiment, the insulator 400 is located above the jelly roll 100. In some embodiments, the insulator 400 is in contact with at least the rubbing region 115 of the jelly roll 100. In one example, the insulator 400 is positioned to provide electrical insulation between the rubbing region 115 and the battery cell case 205 to prevent a short circuit between the rubbing region 115 and the battery cell case 205. In some embodiments, the insulator 400 is positioned to additionally provide electrical insulation between the portions of the jelly roll 100, such as the rubbing region 115, the uncoated portion 110, and or the tab portion 222, and the battery cell case 205. Additionally, as described above, the insulator 400 provides additional mechanical support to the jelly roll 100 by being positioned between at least a portion of the jelly roll 100 and the battery cell case 205.

In some embodiments, the insulator 400 is positioned circumferentially along an inner diameter of the battery cell case 205. By being perpendicular to the battery cell case 205, the insulator 400 spans the diameter of the battery cell case 205, covering a portion of the jelly roll 100 that comes into contact with the battery cell case 205.

The neck portion 405 is configured to prevent contact between the battery cell case 205 and the tab portion 222 of the second weld plate 220. Contact between the battery cell case 205 and the tab portion 222 of the second weld plate 220 may cause a short circuit, which, in some instances, can cause damage to the jelly roll 100. In some embodiments, the insulator 400 is vertically parallel to the tab portion 222 of the second weld plate 220. As described above, the neck portion 405 of the insulator 400 may extends approximately the length of the tab portion 222 of the second weld plate 220.

In some embodiments, the neck portion 405, having inner diameter A, has a radius of about 8.00 mm and diameter of about 16.00 mm. In some embodiments, the neck portion 405 has a height of about 1.00 mm.

In some embodiments, the skirt portion 415, having outer diameter B, has a radius of about 10.00 mm. In some embodiments, the skirt portion 415 has a diameter of about 20.00 mm. In some embodiments, the angular portion 410 and the skirt portion 415 have a height of about 2.00 mm. In some embodiments, the angular portion 410 extends about 0.50 mm outwards to meet the skirt portion 415. In some embodiments, an inner diameter of the insulator 400 at the tapered portion 420 is greater than an inner diameter of the skirt portion 415. However, the values described above are for exemplary purposes only, and it is understood that the insulator 400 may be larger or smaller dimensions based on the size of the jelly roll 100.

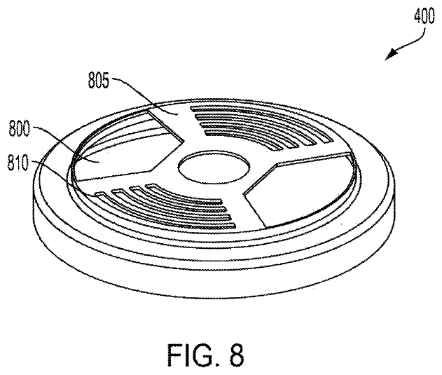

FIG. 8 illustrates an embodiment of the insulator 400. In some embodiments, the insulator 400 includes a number of openings 800 positioned between one or more spoke portions 805. The openings 800 may aid in proper positioning during coupling of the insulator to the jelly roll 100. Proper positioning allows the insulator 400 to function as intended, providing prevention of physical and/or electrical contact between the anode, cathode, and separator sheets of the jelly roll 100 and the battery cell case 205 (or another conductive portion) of the jelly roll battery assembly 200. In one example, the openings 800 correspond to the one or more conductive portions of the second weld plate 220, thereby allowing the corresponding portions of the second weld plate 220 to function as a position indicator or guide to ensure proper positioning of the insulator 400. This may be advantageous for automated assembly as the slots may provide visual indicia to a placement machine or operator that the insulator 400 is in the proper position, such as where the corresponding portions of the second weld plate 220 (or other component of the jelly roll 100) may be visually seen through the openings 800. The insulator will have an increased strength and thus assist in automation.

As shown in FIG. 8, the insulator 400 further include the plurality of spoke portions 805. The plurality of spoke portions 805 increases the strength of the insulator 400 by providing structural members across an opening of the insulator 400 formed substantially by the neck portion 405. The spoke portions 805 allows the insulator 400 may provide additional structural integrity to the insulator 400 and the jelly roll battery assembly 200 in general, and may provide protection from external environmental factors, such as vibrations, falling, shock, etc. that may act upon the jelly roll battery assembly 200. Additionally, between some of the spoke portions 805, the insulator 400 may include one or more slots 810. The slots 810 provide ventilation throughout the jelly roll battery assembly 200, such as between the jelly roll 100 and the terminal 235. This ventilation can reduce heat buildup within the jelly roll 100, thereby increasing lifespan and efficiency.

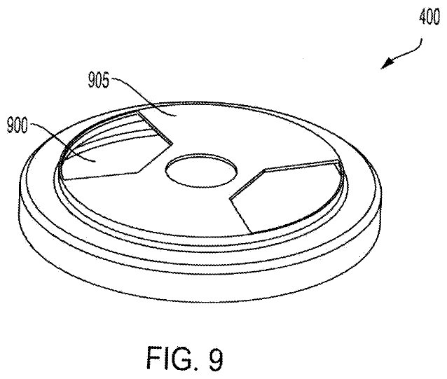

FIG. 9 illustrates another embodiment of the insulator 400. In some embodiments, one or more openings 900 are used for proper positioning of the insulator 400 to the jelly roll 100, which can enable precise positioning during assembly of the jelly roll 100, similar to openings 800 described above. The insulator 400 further includes one or more suction portions 905. The suction portion 905 is designed to allow for one or more suction-based placement devices to easily affix to the insulator 400 via the suction portion 905. This can improve automation by providing an easy access area for a suction-based placement device to attach to the insulator for positioning within the jelly roll battery assembly 200. Furthermore, suction-based placement devices often offer greater control than other placement devices.

Thus, embodiments described herein provide, among other things, an insulator for a jelly roll battery cell. Various features and advantages are set forth in the following claims.

1-20. (canceled)

21. A cylindrical battery cell comprising:
a jelly roll assembly including:
an anode sheet,
a cathode sheet,
a rubbing region positioned at a first end of the jelly roll assembly and formed at a first portion of an uncoated region at the first end of one of the anode sheet and the cathode sheet, and
one or more separator sheets that separate the anode from the cathode;
a header:
a weld plate configured to provide an electrical connection between the jelly roll assembly and the header:
an outer housing; and
an insulator configured to separate a portion of the jelly roll assembly from the outer housing, the insulator including:
a planar portion parallel to a surface of the rubbing region,
a skirt portion parallel to a side of the outer housing, the skirt portion positioned between at least the first portion of the uncoated region and the outer housing,
an angular portion connecting the planar portion to the skirt portion and positioned between the rubbing region and the outer housing, and
a tapered portion parallel to the skirt portion, the tapered portion positioned between at least a portion of the jelly roll assembly and the outer housing.

22. The cylindrical battery cell of claim 21, wherein the insulator further includes a neck portion positioned between the outer housing and an extension portion of the weld plate and parallel to the skirt portion and the tapered portion.

23. The cylindrical battery cell of claim 22, wherein the angular portion is a thickest portion of the insulator.

24. The cylindrical battery cell of claim 23, wherein the skirt portion has a larger diameter than the neck portion.

25. The cylindrical battery cell of claim 23, wherein the insulator is positioned between the jelly roll assembly and the header.

26. The cylindrical battery cell of claim 22, wherein the neck portion prevents electrical contact between the outer housing and an extension of the weld plate.

27. The cylindrical battery cell of claim 21, wherein the tapered portion is positioned between the jelly roll assembly and the outer housing.

28. The cylindrical battery cell of claim 21, wherein the tapered portion protrudes at an angle from the skirt portion, wherein the angle is towards the outer housing.

29. The cylindrical battery of claim 21, wherein the cylindrical battery cell is a tabless battery cell.

30. The cylindrical battery cell of claim 21, wherein the angular portion protrudes at an outward angle towards the outer housing to transition into the skirt portion, and wherein the angle is within a range from 10 degrees to 45 degrees, preferably 30 degrees.

31. A tabless battery cell comprising:
a cylindrical housing:
a header:
a first electrode sheet;
a second electrode sheet;
one or more separator sheets that separates the first electrode sheet and the second electrode sheet, wherein the first electrode sheet, the second electrode sheet, and the one or more separator sheets are rolled together to form a jelly roll assembly, the jelly roll assembly further including a rubbing region formed at a first end of the jelly roll assembly;
a weld plate coupled to the rubbing region; and
an insulator positioned between the jelly roll assembly and the cylindrical housing at the first end, the insulator including:
a neck portion positioned between the cylindrical housing and an extension portion of the weld plate,
a skirt portion parallel to the neck portion, the skirt portion positioned between at least a first portion of the jelly roll assembly and the cylindrical housing,
an angular portion connecting the neck portion to the skirt portion and positioned between the rubbing region and the cylindrical housing, and
a tapered portion parallel to both the neck portion and the skirt portion, the tapered portion is positioned between at least a portion of the jelly roll assembly and the cylindrical housing.

32. The tabless battery cell of claim 31, wherein the skirt portion has a larger diameter than the neck portion.

33. The tabless battery cell of claim 31, wherein the insulator is positioned between the jelly roll assembly and the header.

34. The tabless battery cell of claim 31, wherein the neck portion prevents electrical contact between the cylindrical housing and the extension portion of the weld plate.

35. The tabless battery cell of claim 31, wherein the first portion of the jelly roll assembly includes a portion of an uncoated region of one of the first electrode sheet or the second electrode sheet.

36. The tabless battery cell of claim 31, wherein the insulator is comprised of perfluoroalkoxy or polyethylene terephthalate.

37. An insulator of a tabless battery cell, comprising:
a planar portion parallel to a surface of a rubbing region of the tabless battery cell:
a skirt portion parallel to a side of an outer housing of the tabless battery cell, wherein the skirt portion is positioned between a portion of a rolled electrode assembly of the tabless battery cell and the outer housing:
an angular portion protruding at an angle to a vertical direction from the planar portion, the angular portion connecting the planar portion to the skirt portion; and
a tapered portion parallel to the skirt portion, wherein the tapered portion is positioned below the skirt portion.

38. The insulator of claim 37, further comprising a neck portion positioned between the outer housing and an extension portion of a weld plate of the tabless battery cell and parallel to the skirt portion and the tapered portion.

39. The insulator of claim 37, wherein the angle is within a range from 10 degrees to 45 degrees, preferably 30 degrees.

40. The insulator of claim 37, wherein the angular portion is a thickest portion of the insulator.
